(19) United States
(12) Patent Application Publication
(10) Pub. No.: US 2006/0019073 A1
(43) Pub. Date: Jan. 26, 2006

(54) Personalization and advertising display for electronic devices

(75) Inventors: J. Marc Kinley, Fort Mill, SC (US); James S. Carter, Huntersville, NC (US); David L. Graves, Rock Hill, SC (US)

Correspondence Address: Adams Evans P.A.;2180 Two Wachovia Center, 301 S. Tryon Street, Charlotte, NC, 28282, US

(73) Assignee: NMOTION LLC, Fort Mill, SC (US)

(21) Appl. No.: 11/184,165

(22) Filed: Jul. 19, 2005

Related U.S. Application Data
(60) Provisional application No. 60/589,127, filed on Jul. 19, 2004.

(51) Int. Cl. B32B 3/00

(52) U.S. Cl. 428/195.1

(57) ABSTRACT

A multiple-layer, laminated display having an adhesive layer for adhering the display to a support surface, a base layer, a printing layer defining an image applied to the base layer, and a doming cover applied over the printing layer to form a three-dimensional surface that can heal itself if scratched or indented, while safeguarding the quality of the underlying printing layer and image. The adhesive layer, base layer, printing layer and doming cover are overlaid in registration with each other to form a unit.

### TECHNICAL FIELD AND BACKGROUND OF INVENTION

This invention relates to articles in the general form of a sheet bearing text and/or graphics that permit personalization and advertising for electronic devices such as computers, PDAs and the like. The invention permits previously unadorned areas of such devices to be used to display advertising logos and personal identification, among other text and graphics displays.

There are multiple methods to communicate thought, ideas, and content through media such as radio, television, billboards, and print. Because of the increased use of portable electronic devices such as laptops, PDAs, and cell phones, a new medium has emerged. Currently, external surfaces of portable electric devices are only used to display the brand of the device manufacturer's and/or it's components. These surfaces are not utilized to display other content. This invention thus relates to an article for presenting and communicating through electronic or printed image(s) displayed on one or more external surfaces of a portable electronic device. It introduces a unique and creative way to communicate leveraging portability and visibility.

The article according to the invention provides to a person, corporation, government or other entity the ability to present and communicate such things as, but not limited to ideas, concepts, art, names, brands, logos, trademarks, slogans, and other content. This method is accomplished by displaying one or more electronic or printed images covering a large portion of the external surface of a portable electronic device, such as the top of the cover of a laptop computer.

### SUMMARY OF THE INVENTION

According to one embodiment of the invention, a multiple-layer, laminated display is provided, and comprises an adhesive layer for adhering the display to a support surface, a base layer, a printing layer defining an image applied to the base layer, and a doming cover applied over the printing layer to form a three-dimensional surface that can heal itself if scratched or indented, while safeguarding the quality of the underlying printing layer and image.

The adhesive layer, base layer, printing layer and doming cover are overlaid in registration with each other to form a unit.

According to another embodiment of the invention, the adhesive layer is selected from the group consisting of rubber-based, acrylic, modified acrylic, and silicone pressure-sensitive adhesives, the base layer is selected from the group consisting of polyester, vinyl, polycarbonate, leather, plastics and metals, the printing layer is selected from the group consisting of a digital transfer using a color thermal transfer foil, a screen print using ultraviolet inks, solvent-based inks, enamel inks or epoxy inks, a flexographic print using ultraviolet inks, water-based inks or solvent-based inks, an offset print, and electronic inks; and the doming cover comprises a polyurethane photopolymer coating applied over the printing layer to form a three-dimensional surface.

According to yet another embodiment of the invention, a multi-layer, laminated display is provided, comprising an adhesive layer applied to a first surface of a base layer and a printing layer forming an image applied to a second, opposed surface of the base layer, wherein the adhesive layer is selected from the group consisting of rubber-based, acrylic, modified acrylic, and silicone pressure-sensitive adhesives, the base layer is selected from the group consisting of polyester, vinyl, polycarbonate, leather, plastics and metals, and the printing layer is selected from the group consisting of a digital transfer using a color thermal transfer foil, a screen print using ultraviolet inks, solvent-based inks, enamel inks or epoxy inks, a flexographic print using ultraviolet inks, water-based inks or solvent-based inks, an offset print, and electronic inks.

According to yet another embodiment of the invention a doming cover is applied over the printing layer to form a three-dimensional protective surface that can heal itself if scratched or indented, while safeguarding the quality of the underlying printing layer and image.

According to yet another embodiment of the invention, the doming cover comprises a polyurethane photopolymer coating applied over the printing layer to form a three-dimensional surface.

According to yet another embodiment of the invention the adhesive layer comprises an adhesive selected from the group consisting of hot-melt, spray, liquid, epoxy, light-cure and cyanoacrylate adhesives.

According to yet another embodiment of the invention a removable backing sheet is provided for protecting the adhesive until application.

According to yet anotherembodiment of the invention a finish sheet is applied over the doming cover to provide a gloss, matte or textured finish.

### BRIEF DESCRIPTION OF DRAWINGS

The invention will be further described with reference to the following drawings, in which:

FIG. 1 is a perspective view of an article according to the invention;

FIG. 2 is a perspective view of an article according to the invention applied to the top cover of a laptop computer;

FIG. 3 is a cross-sectional view of one embodiment of the article shown in FIG. 1; and

FIG. 4 is a cross-sectional view of another embodiment of the article.

### DETAILED DESCRIPTION OF PREFERRED EMBODIMENT

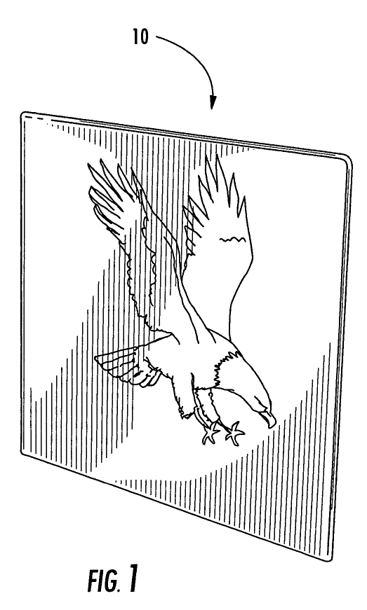

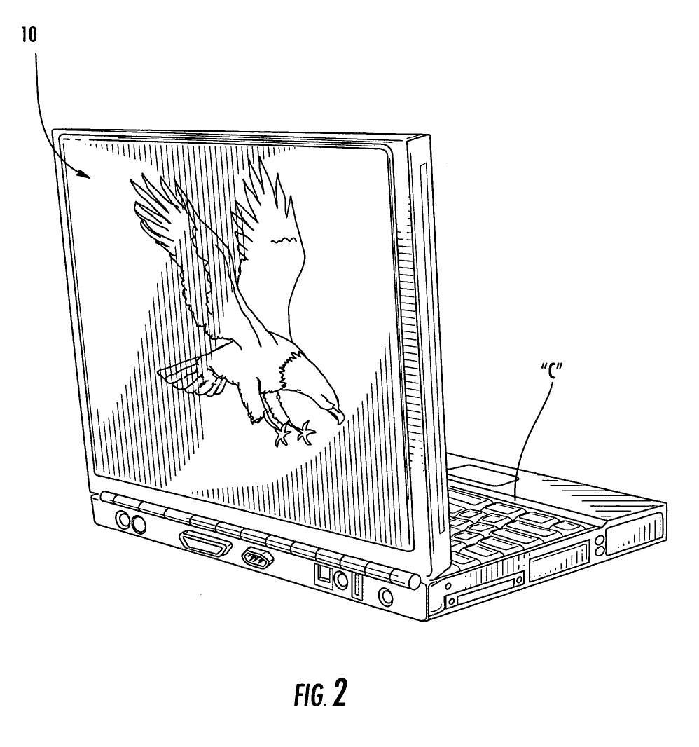

Referring now to the drawings, a personalization and advertising article according to an embodiment of the invention is shown in FIG. 1 at reference numeral 10. The article 10 is adhered to the surface of the laptop computer “C”, as shown in FIG. 2, and thereafter serves to personalize the laptop and/or advertise a desired product or service.

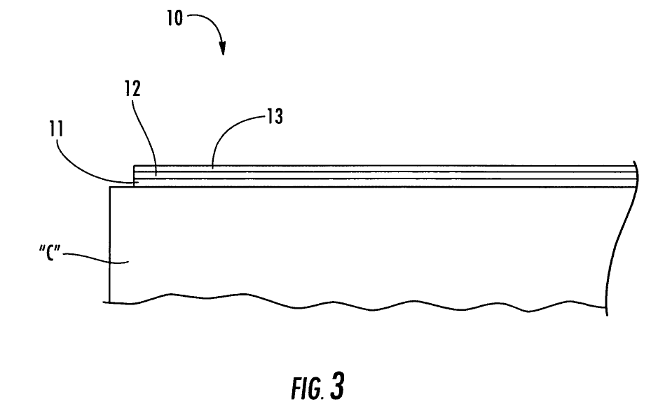

Referring now to FIG. 3, the article 10 is preferably comprised of multiple layers; an adhesive layer 11, a base layer 12, and a printing layer 13.

The adhesive layer is preferably a pressure-sensitive adhesive (“PSA”). A PSA is defined as “a distinct category of adhesive that in dry form are aggressive and permanently tacky at room temperature.” PSAs adhere to a variety of substrates when applied with pressure; do not require activation by water, heat, or solvents; and have sufficient cohesive strength to be handled with the fingers. The primary mode of bonding for a PSA is not chemical or mechanical but rather a polar attraction to the substrate, and always requires pressure to achieve sufficient wet-out onto the surface to provide adequate adhesion. There are many properties that need to be taken into account when manufacturing a PSA, the three principal ones relating to the performance factors of adhesion, tack, and shear.

The PSA layer 11 may be any of the four main varieties of PSAs-rubber-based, acrylic, modified acrylic, and silicone formulations. Each of these types exhibits distinct performance characteristics, as shown below:

TABLE 1

| | Rubber- | | Modified | |
|---|---|---|---|---|
| Characteristic | Based | Acrylic | Acrylic | Silicone |
| Cost | Lowest | Medium/ | Medium/ | Very high |
| | | high | high | |
| Tack | Medium/ | Medium/ | High | Low |
| | high | low | | |
| Temperature | Low | High | Low/ | Very high |
| resistance | | | moderate | |
| Adhesion | Medium/ | Moderate/ | High | Medium/ |
| | high | high | | low |
| Shear | Medium/ | Moderate/ | Low | Moderate |
| | high | high | | |
| Solvent | Poor | Good | Low/ | Excellent |
| resistance | | | moderate | |
| Ultraviolet | Poor | Excellent | Poor | Excellent |
| resistance | | | | |
| Plasticizer | Poor | Moderate/ | Poor/ | Excellent |
| resistance | | good | moderate | |
| Low-surface- | Excellent | Poor/ | Excellent | Poor |
| energy materials | | moderate | | |
| High-surface- | Excellent | Excellent | Excellent | Moderate |
| energy materials | | | | |

Alternative adhesive types such as hot-melt, spray, liquid, epoxy, and cyanoacrylate adhesives hot melts or spray, liquid, or light-cure adhesives are also usable as the adhesive layer 11. Hot melt adhesives are polymeric thermoplastic compounds that are applied molten and form a bond upon cooling. Spray adhesives are generally solvent-borne systems applied to the substrate via air-pressure mist. Overspray and solvent emissions are among the application issues that can be of concern with sprays. Liquid adhesives are available in emulsion or solvent varieties, and require brush or roller coating to apply, whereas light-cured adhesives are products that cure when exposed to UV or visible light. Other common adhesive formulations include urethanes and cyanoacrylates.

The preferred adhesive is acrylic.

The preferred PSA is protected until application by means of a removable backing sheet, not shown, that covers and protects the adhesive until it is removed immediately prior to application. The backing sheet retards drying of the adhesive and protects the adhesive from contamination and diminution in tack characteristics.

The adhesive layer 11 is applied to one side of the base 12. The base 12 may comprise a number of substrate materials, such as:
1. Polyester—(generic term for the material sold under the trademark “Mylar”) either gloss, matte, or metalized formats.
2. Vinyl—in either gloss or matte formats.
3. Polycarbonate—either gloss (textured and non-textured) or matte (textured and non-textured). This product would not contain a Layer 4.
4. Leather—either embossed, printed, or stitched.
5. Plastics—with printed images.
6. Metals—including gold, silver, platinum, aluminum, alloys, etc either molded or with printed image.

The substrate 12 receives the printed layer 13, comprising printed or other graphic material, applied according to processes that include:
1. Digital transfer using a color thermal transfer foil such as one sold Gerber Scientific Products, utilizing single pass printing.
2. Screen printing using ultraviolet inks, solvent-based inks, enamel inks and/or epoxy inks.
3. Flexographic printing using ultraviolet inks, water-based inks and/or solvent-based inks.
4. Offset printing.
5. Electronic inks on higher resolution active matrix TFT backplanes and electronic ink on lower resolution direct drive plastic backplanes.

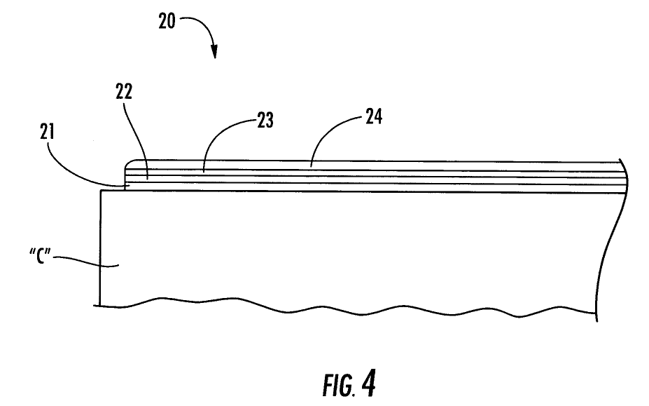

Referring now to FIG. 4, an article 20 includes adhesive, base and printing layers 21, 22 and 23, respectively, as well as a “dome cap” layer 24 in the form of a urethane doming. Urethane doming is a polyurethane photopolymer coating that is applied over the printed image of layer 13. The result is a domed, 3 dimensional surface that can heal itself if scratched or indented, while safeguarding the quality of the underlying graphics material.

The dome cap layer 24 may either be type a “C” doming compound of the type used for indoor appliances, such as ‘CPU’ logos and electronic instruments, or a type “D” doming compound of the type approved for outdoor usage. Type “D” doming is engineered for the use on items, such as automotive decals, that are exposed continuously to direct sunlight. Doming can be added to most applications and not only gives added protection to product identification, but also provides a high end look that provides enhanced value to the article 20.

In addition, a vinyl or polyester sheet or coating, not shown, may be added for a gloss or matte finish, and a polycarbonate layer may be added if a textured surface is desired.

The full range of applications is extensive, but includes laptop computers, PDAs, POS credit card machines, ATMs, Mobile and cellular phones, pagers, and other handheld devices, full-size computers, monitors, printers, scanners, fax machines and similar appliances.

A personalization and advertising display for electronic devices is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A multiple-layer, laminated display, comprising:
(a) an adhesive layer for adhering the display to a support surface;
(b) a base layer having the adhesive layer applied to a first side thereof;
(c) a printing layer defining an image applied to a second side of the base layer;
(d) a doming cover applied over the printing layer to form a three-dimensional surface that can heal itself if scratched or indented, while safeguarding the quality of the underlying printing layer and image; and
(e) the adhesive layer, base layer, printing layer and doming cover overlaid in registration with each other to form a unit.

2. A multi-layer display according to claim 1, wherein:
(a) the adhesive layer is selected from the group consisting of rubber-based, acrylic, modified acrylic, and silicone pressure-sensitive adhesives;
(b) the base layer is selected from the group consisting of polyester, vinyl, polycarbonate, leather, plastics and metals;
(c) the printing layer is selected from the group consisting of a digital transfer using a color thermal transfer foil, a screen print using ultraviolet inks, solvent-based inks, enamel inks or epoxy inks, a flexographic print using ultraviolet inks, water-based inks or solvent-based inks, an offset print, and electronic inks; and
(d) the doming cover comprises a polyurethane photopolymer coating applied over the printing layer to form a three-dimensional surface.

3. A multi-layer, laminated display, comprising:
(a) an adhesive layer applied to a first surface of a base layer and a printing layer forming an image applied to a second, opposed surface of the base layer, wherein:
(b) the adhesive layer is selected from the group consisting of rubber-based, acrylic, modified acrylic, and silicone pressure-sensitive adhesives;
(c) the base layer is selected from the group consisting of polyester, vinyl, polycarbonate, leather, plastics and metals; and
(d) the printing layer is selected from the group consisting of a digital transfer using a color thermal transfer foil, a screen print using ultraviolet inks, solvent-based inks, enamel inks or epoxy inks, a flexographic print using ultraviolet inks, water-based inks or solvent-based inks, an offset print, and electronic inks.

4. A multi-layer display according to claim 3, and including a doming cover applied over the printing layer to form a three-dimensional protective surface that can heal itself if scratched or indented, while safeguarding the quality of the underlying printing layer and image.

5. A multi-layer display according to claim 4, wherein the doming cover comprises a polyurethane photopolymer coating applied over the printing layer to form a three-dimensional surface.

6. A multi-layer display according to claim 1, wherein the adhesive layer comprises an adhesive selected from the group consisting of hot-melt, spray, liquid, epoxy, light-cure and cyanoacrylate adhesives.

7. A multi-layer display according to claim 1, and including a removable backing sheet for protecting the adhesive until application.

8. A multi-layer display according to claim 1, and including a finish sheet applied over the doming cover to provide a gloss, matte or textured finish.
